(19) United States
(12) Patent Application Publication
(10) Pub. No.: US 2026/0336166 A1
(43) Pub. Date: Oct. 29, 2026

(54) OVERMOLDED THERMOPLASTIC ARTICLES AND METHODS OF RECOVERING HIGH-PURITY THERMOPLASTIC MATERIAL THEREFROM

(71) Applicant: AVIENT CORPORATION, Avon Lake, OH (US)

(72) Inventors: Jian ZHOU, Avon, OH (US); Charles W. MCDANIEL, Elyria, OH (US)

(21) Appl. No.: 19/101,708

(22) PCT Filed: Aug. 10, 2023
(86) PCT No.: PCT/US2023/071980

§ 371 Date: Feb. 6, 2025

Related U.S. Application Data
(60) Provisional application No. 63/397,146, filed on Aug. 11, 2022.

(51) Int. Cl. B29B 17/02; B29B 17/00; B29K 21/00; B29K 101/12; B32B 27/08; B32B 27/20

(52) U.S. Cl. CPC B29B 17/02; B29B 17/0005; B32B 27/08; B32B 27/20; B29B 2017/0272; B29B 2017/0279; B29K 2021/003; B29K 2101/12; B32B 2307/208; B32B 2307/422

(57) ABSTRACT

Overmolded thermoplastic articles include a base component comprising rigid thermoplastic material and an overmold component comprising thermoplastic elastomer material. Either the base component or the overmold component, but not both, includes magnetic separation additive in an amount ranging from about (0.07/R) wt % to about (0.25/R) wt %, based on weight of the component in which the magnetic separation additive is present, wherein the magnetic separation additive has a magnetic induction at saturation point of about (1.7*R) tesla, and R is a value from about 0.1 to about 2.

### CLAIM OF PRIORITY

This application claims priority from U.S. Provisional Patent Application Ser. No. 63/397,146 bearing Attorney Docket Number 1202215-US-F and filed on Aug. 11, 2022, which is hereby incorporated by reference in its entirety.

### TECHNICAL FIELD

The present disclosure relates to thermoplastic articles, and, more particularly, overmolded thermoplastic articles and methods of recovering high-purity thermoplastic materials from the overmolded thermoplastic articles.

### BACKGROUND

Multicomponent thermoplastic articles which have two or more components formed from dissimilar plastic materials may be used for achieving multiple functionalities in various applications, including protective cases for personal electronics such as smartphones, tablets, laptops, and the like. Various industries, including the consumer electronics industry, desire thermoplastic articles that include increasingly higher content of post-consumer and/or post-industrial recycled materials. However, it may be difficult to obtain high-purity materials from post-consumer recycling and post-industrial recycling of multicomponent thermoplastic articles.

Accordingly, a need exists for multicomponent thermoplastic articles which may be more efficiently recycled and from which high-purity thermoplastic materials may be recovered.

### SUMMARY

Embodiments of the present disclosure are directed to overmolded thermoplastic articles and methods of recovering high-purity thermoplastic materials from the overmolded thermoplastic articles.

According to some embodiments, an article is provided. The article comprises a base component comprising rigid thermoplastic material and an overmold component comprising thermoplastic elastomer material. Either the base component or the overmold component, but not both, comprises magnetic separation additive in an amount ranging from about (0.07/R) wt % to about (0.25/R) wt %, based on weight of the component in which the magnetic separation additive is present, wherein the magnetic separation additive has a magnetic induction at saturation point of about (1.7*R) tesla as measured by a vibrating sample magnetometer at 25 °C, and R is a value from about 0.1 to about 2.

According to other embodiments, a method is provided. The method is directed to recovering a high-purity recovered thermoplastic material from an overmolded thermoplastic article. The method comprises the steps of (a) providing the article as disclosed herein as the overmolded thermoplastic article; (b) reducing the overmolded thermoplastic article to provide a regrind mixture; (c) separating the regrind mixture into at least (i) a first fraction collected in a first bin, (ii) a second fraction collected in a second bin, and (iii) a third fraction collected in a third bin. The step of separating is performed by a magnetic pulley separator equipped with a rare-earth magnetic roll.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DRAWINGS

FIG. 1 is a schematic view of an exemplary article, according to one or more embodiments shown and described herein;

FIG. 2 is a schematic view of an exemplary configuration of a magnetic pulley separator, according to one or more embodiments shown and described herein;

FIG. 3 is a schematic view of another exemplary article, according to one or more embodiments shown and described herein;

FIG. 4 is a schematic view of another exemplary article, according to one or more embodiments shown and described herein;

FIG. 5 is a schematic view of another exemplary article, according to one or more embodiments shown and described herein; and

FIG. 6 is a schematic view of another exemplary configuration of a magnetic pulley separator, according to one or more embodiments shown and described herein.

### DETAILED DESCRIPTION

Reference is made hereinafter in detail to various embodiments of articles and methods.

Articles as disclosed herein comprise a base component comprising rigid thermoplastic material and an overmold component comprising thermoplastic elastomer material. Either the base component or the overmold component, but not both, comprises magnetic separation additive in an amount ranging from about (0.07/R) wt % to about (0.25/R) wt %, based on weight of the component in which the magnetic separation additive is present, wherein the magnetic separation additive has a magnetic induction at saturation point of about (1.7*R) tesla as measured by a vibrating sample magnetometer at 25 °C, and R is a value from about 0.1 to about 2.

Methods as disclosed herein are directed to recovering a high-purity recovered thermoplastic material from an overmolded thermoplastic article and comprise the steps of (a) providing the article as disclosed herein as the overmolded thermoplastic article; (b) reducing the overmolded thermoplastic article to provide a regrind mixture; (c) separating the regrind mixture into at least (i) a first fraction collected in a first bin, (ii) a second fraction collected in a second bin, and (iii) a third fraction collected in a third bin. The step of separating is performed by a magnetic pulley separator equipped with a rare-earth magnetic roll.

The disclosure should not be construed as limited to the embodiments set forth herein. Rather, these embodiments are provided so that this disclosure will be thorough and complete, and will fully convey the subject matter to those skilled in the art.

### DEFINITIONS

Unless otherwise expressly defined, all technical and scientific terms used herein have the same meaning as commonly understood by a person of ordinary skill in the art. The terminology used in the disclosure herein is for describing particular embodiments only and is not intended to be limiting.

Unless otherwise expressly stated, it is not intended that any method disclosed herein be construed as requiring that its steps be performed in a specific order, nor that any apparatus article set forth herein be construed as requiring specific orders or orientations to its individual components.

Unless otherwise expressly stated, it is intended that any composition or mixture disclosed herein may comprise, consist essentially of, or consist of the disclosed components.

As used herein, the singular form of a term is intended to include the plural form of the term, unless the context clearly indicates otherwise.

As used herein, numerical values are not strictly limited to the exact numerical value recited. Instead, unless otherwise expressly stated, each numerical value is intended to mean both the exact numerical value and “about” the numerical value which encompasses (i.e., a functionally equivalent range surrounding that numerical value), such that either possibility is contemplated as an embodiment disclosed herein.

As used herein, the term “300% tensile modulus” refers to a stress value for a material at 300% strain as measured according to ASTM D412.

As used herein, the term “dielectric constant” refers to the dielectric constant of a material as measured according to a resonant cavity method with frequencies between 35 and 42 GHz, with a dielectric constant measured at 40 GHz being representative of the frequency range.

As used herein, the term “essentially free” refers to when used to describe the amount and/or absence of a particular component, means that the component is not intentionally added. However, in embodiments, the component may be present in an amount of less than 0.05 wt % or 0.03 wt % or 0.01 wt % or 0.005 wt % or 0.001 wt %.

As used herein, the term “flexural modulus” refers the ratio of stress to strain in flexural deformation as measured according to ASTM D790 at 23 °C and a rate of strain 0.2 mm/min.

As used herein, the term “formed from” (including related terms such as “forming”) refers to, with respect to an article (or component of an article) and a thermoplastic material, that the article (or component of the article) is extruded, molded, shaped, pressed, or otherwise made, in whole or in part, from the thermoplastic material under sufficient heating to enable such forming. As such, the term “formed from” (including related terms such as “forming”) means, in some embodiments, the article (or component of an article) can comprise, consist essentially of, or consist of, the material; and, in other embodiments, the article (or component of an article) consists of the material because the article (or component of an article) is, for example, made by an extrusion process or a molding process.

As used herein, the term “high-purity” refers to a composition or mixture in which a particular substance or material is present in an amount greater than or equal to, in various embodiments, 80 wt %, or 85 wt %, or 90 wt %, or 92 wt %, or 95 wt %, or 97 wt %, or 98 wt %, or 99 wt %, or 99.5 wt %, or 99.9 wt %.

As used herein, the term “magnetic induction” refers to the magnetic susceptibility of a substance or material when it is in a magnetic field. The unit of measure is the tesla (T).

As used herein, the term “neat” refers to a substance or material that is pure or substantially pure such that it is present as a single distinct substance or material without any other distinct substance(s) or material(s) being present in combination at level(s) greater than trace amount(s) using methodology and equipment that are conventional for detecting such substance(s) or material(s).

As used herein, the term “recovered” refers to a material coming from a recycled source.

As used herein, the term “saturation point” refers to, in the context of a substance or material that is magnetically susceptible, the state reached when an increase in an applied external magnetic field cannot further increase the magnetization of the substance or material.

As used herein, the term “Shore A hardness” refers to the hardness of a material, as measured according to ASTM D2240.

As used herein, the term “specific gravity” refers to the ratio of the density of a material to the density of water and is measured according to ASTM D792.

As used herein, the term “tensile elongation” refers to the tensile elongation at break, which is the ratio between increased length and initial length after breakage as measured according to ASTM D412, Die C.

As used herein, the term “tensile strength” refers to the tensile strength at break, which is the maximum stress that a material can withstand while stretching before breaking as measured according to ASTM D412, Die C.

As used herein, the term “virgin” refers to a material coming from a source other than a recycled source.

### Usefulness

As discussed hereinabove, multicomponent thermoplastic articles which have two or more components formed from dissimilar plastic materials, such as overmolded thermoplastic articles, may be used for achieving multiple functionalities in various applications, including protective cases for personal electronics such as smartphones, tablets, laptops, and the like. For example, an elastomeric component may be bonded to a rigid resin component to provide a balanced performance, including overall stiffness, impact resistance, and shock absorption, while also providing desired aesthetics (look or appearance) and/or haptics (touch or feel).

Various industries, including the consumer electronics industry, desire thermoplastic articles that include increasingly higher content of post-consumer and/or post-industrial recycled materials. However, it may be difficult to obtain high-purity materials, particularly high-purity thermoplastic elastomer, from post-consumer recycling and post-industrial recycling of multicomponent thermoplastic articles.

In a conventional recycling process, multicomponent articles may be granulated, separated, and reprocessed (e.g., melted and extruded) for further use. Conventional material separation methods for a plastic regrind include float-sink method (density based), centrifuge method (density based), electrostatic sorting, optical sorting using near-infrared spectroscopy, and magnetic separation. Multicomponent articles with a thermoplastic elastomer overmold layer on a rigid thermoplastic base layer are typically designed to have strong interfacial bonding between the thermoplastic elastomer overmold layer and the rigid thermoplastic base layer to endure normal wear and tear and even mechanical abuses of the articles during use. Strong interfacial bonding often can survive an industrial grinding process involving mechanical shearing, tearing, and cutting of the articles for recycling purpose, resulting in a significant portion of hybrid particles having both a thermoplastic elastomer portion and a rigid thermoplastic portion among the regrind of such articles. The hybrid particles would typically be regarded as an undesirable contaminant in either a thermoplastic elastomer rich fraction or a rigid thermoplastic rich fraction that may be obtained by a conventional separation process. The separated and recovered thermoplastic elastomer rich fraction or recovered rigid thermoplastic rich fraction may still have a high level of the other thermoplastic material component due to the presence of the hybrid particles after the conventional separation process, which negatively affects the properties of the recovered thermoplastic elastomer material or recovered rigid thermoplastic rich fraction.

Therefore, currently, multicomponent articles, such as overmolded thermoplastic articles, cannot practically be recycled to provide recovered materials with high purity, and recovered materials typically are suitable for further uses in forming new articles only after mixing with relatively larger amounts of virgin resin (e.g., more virgin resin than recycled resin in a mixture of virgin resin and recycled resin).

The articles and methods disclosed herein address the aforementioned problems.

### Article

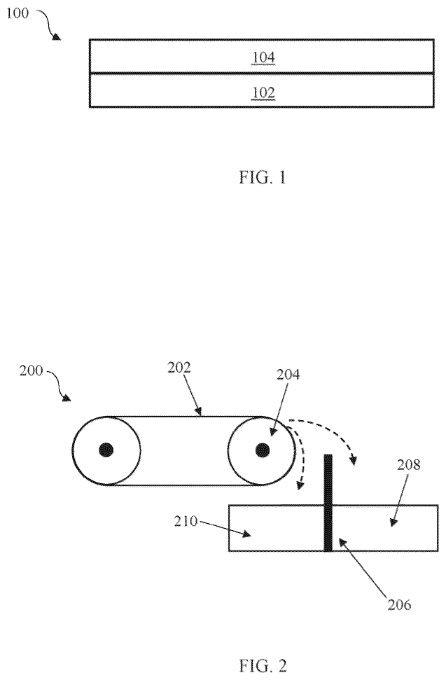

Referring now to FIG. 1, the articles 100 disclosed herein comprise a base component 102 and an overmold component 104.

In embodiments, either the base component 102 or the overmold component 104, but not both, may comprise magnetic separation additive.

In embodiments, at least a portion of the overmold component 104 may be affixed by interfacial bonding onto at least a portion of the base component 102.

In embodiments, the overmold component 104 may be molded onto at least one side of the base component 102. For example, a typical overmolding process may include pressing a melt of overmold component 104 onto at least one side of the previously formed base component 102 in a molding cavity and then cooling to form the article 100. With a typical overmolding process, the base component 102 and the overmold component 104 may be bonded to each other without the need for adhesive.

In embodiments, the bond between the base component 102 and the overmold component 104 is relatively strong such that a regrind mixture obtained by physically reducing (e.g., grinding) the article 100 and having an average particle size between about 1 mm and about 10 mm may include at least 10 wt % of hybrid particles (i.e., particles having both a substantial portion consisting of the base component 102 and substantial portion consisting of the overmold component 104), based on a total weight of the regrind.

In embodiments, the articles 100 disclosed herein may further comprise a photoluminescent marker.

In embodiments, the articles 100 disclosed herein may further comprise one or more additional components comprising one or more additional thermoplastic materials as described hereinafter.

In embodiments, the article may be a protective case or cover for an electronic device, and the electronic device is capable of sending and/or receiving wireless telecommunication signals at frequencies between about 1 GHz and about 50 GHz.

### Base Component and Rigid Thermoplastic Material

As disclosed herein, the base component 102 comprises rigid thermoplastic material.

In embodiments, the base component 102 may be formed from the rigid thermoplastic material.

In embodiments, the base component may comprise rigid thermoplastic material and optional other additives. Additionally, in embodiments, the base component may comprise magnetic separation additive, provided that the magnetic separation additive is not also present in the overmold component and/or the thermoplastic elastomer material. Also additionally, in embodiments, the base component may further comprise a photoluminescent marker.

In embodiments, the rigid thermoplastic material may comprise thermoplastic resin and optional other additives. Additionally, in embodiments, the rigid thermoplastic material may comprise magnetic separation additive, provided that the magnetic separation additive is not also present in the overmold component and/or the thermoplastic elastomer material. Also additionally, in embodiments, the rigid thermoplastic material may further comprise a photoluminescent marker.

In embodiments, the base component and/or the rigid thermoplastic material may have a flexural modulus greater than or equal to about 1000 MPa or greater than or equal to about 1200 MPa; and less than or equal to about 3000 MPa or less than or equal to about 2500 MPa; for example, from about 1000 MPa to about 3000 MPa, from about 1000 MPa to about 2500 MPa, from about 1500 MPa to about 3000 MPa, or from about 1500 MPa to about 2500 MPa, or any and all subranges formed from any of these endpoints.

In embodiments, the base component and/or the rigid thermoplastic material may have a density greater than or equal to about 1.0 g/cm³ or greater than or equal to about 1.1 g/cm³; and less than or equal to about 1.3 g/cm³ or less than or equal to about 1.2 g/cm³; for example, from about 1.0 g/cm³ to about 1.3 g/cm³, from about 1.0 g/cm³ to about 1.2 g/cm³, from about 1.1 g/cm³ to about 1.3 g/cm³, or from about 1.1 g/cm³ to about 1.2 g/cm³, or any and all subranges formed from any of these endpoints.

### Thermoplastic Resin

In embodiments, the rigid thermoplastic material may comprise thermoplastic resin.

Suitable thermoplastic resins may include conventional or commercially available thermoplastic resins. A thermoplastic resin may be used alone or in combination with one or more other thermoplastic resins.

In embodiments, the thermoplastic resin may be selected from the group consisting of polycarbonates, thermoplastic polyesters, polyamides, aliphatic polyketones, acrylonitrile butadiene styrenes, polypropylenes, and combinations thereof.

In embodiments, the thermoplastic resin may be selected from virgin thermoplastic resin, recycled (recovered) thermoplastic resin, or combinations thereof.

Suitable commercial embodiments of thermoplastic resin are available under the MARKROLON brand from Covestro, such as polycarbonate grade 2407.

In embodiments, the thermoplastic resin may be present in the rigid thermoplastic material in an amount from about 50 wt % to about 99.95 wt %, based on weight of the rigid thermoplastic material, or any and all subranges formed between these endpoints. For example, in embodiments, the thermoplastic resin may be present in an amount in the rigid thermoplastic material from about 60 wt % to about 99.95 wt %, or from about 70 wt % to about 99.95 wt %, or from about 80 wt % to about 99.95 wt %, or from about 90 wt % to about 99.95 wt %, or from about 95 wt % to about 99.95 wt %, based on weight of the rigid thermoplastic material, or any and all subranges formed between any of these endpoints.

### Overmold Component and Thermoplastic Elastomer Material

As disclosed herein, the overmold component 104 comprises thermoplastic elastomer material.

In embodiments, the overmold component 104 may be formed from the thermoplastic elastomer material.

In embodiments, the overmold component may comprise thermoplastic elastomer, optional polymeric chain extender, and optional other additives. Additionally, in embodiments, the overmold component may comprise magnetic separation additive, provided that the magnetic separation additive is not also present in the base component and/or the rigid thermoplastic material. Also additionally, in embodiments, the overmold component may further comprise a photoluminescent marker.

In embodiments, the thermoplastic elastomer material may comprise thermoplastic elastomer, optional polymeric chain extender, and optional other additives. In addition, in embodiments, the thermoplastic elastomer material may comprise magnetic separation additive provided that the magnetic separation additive is not also present in the base component and/or the rigid thermoplastic material. Also additionally, in embodiments, the thermoplastic elastomer material may further comprise a photoluminescent marker.

Suitable commercial embodiments of thermoplastic elastomer material are available under the VERSAFLEX brand from Avient Corporation, such as thermoplastic polyurethane grade CE 3120-65.

In embodiments, the overmold component and/or the thermoplastic elastomer material may have a Shore A hardness greater than or equal to about 50 or greater than or equal to about 60; and less than or equal to about 80 or less than or equal to about 70; for example, from about 50 to about 80, from about 50 to about 70, from about 60 to about 80, or from about 60 to about 70, or any and all subranges formed from any of these endpoints.

In embodiments, the overmold component and/or the thermoplastic elastomer material may have a specific gravity greater than or equal to about 1.0 or greater than or equal to about 1.1; and less than or equal to about 1.3 or less than or equal to about 1.2; for example, from about 1.0 to about 1.3, from about 1.0 to about 1.2, from about 1.1 to about 1.3, or from about 1.1 to about 1.2, or any and all subranges formed from any of these endpoints.

In embodiments, the overmold component and/or the thermoplastic elastomer material may have a tensile strength greater than or equal to about 12 MPa or greater than or equal to about 14 MPa; and less than or equal to about 19 MPa or less than or equal to about 17 MPa; for example, from about 12 MPa to about 19 MPa, from about 12 MPa to about 17 MPa, from about 14 MPa to about 19 MPa, from about 14 MPa to about 17 MPa, or any and all subranges formed from any of these endpoints.

In embodiments, the overmold component and/or the thermoplastic elastomer material may have a tensile elongation greater than or equal to about 550% or greater than or equal to about 650%; and less than or equal to about 850% or less than or equal to about 750%; for example, from about 550% to about 850%, from about 550% to about 750%, from about 650% to about 850%, or from about 650% to about 750%, or any and all subranges formed from any of these endpoints.

In embodiments, the overmold component and/or the thermoplastic elastomer material may have a 300% tensile modulus greater than or equal to about 0.07 MPa, greater than or equal to about 0.1 MPa, greater than or equal to about 0.5 MPa, greater than or equal to about 1 MPa, or greater than or equal to about 3 MPa; and less than or equal to about 15 MPa, less than or equal to about 12 MPa, less than or equal to about 10 MPa, less than or equal to about 8 MPa, or less than or equal to about 6 MPa; for example, from about 0.07 MPa to about 15 MPa, from about 0.07 MPa to about 12 MPa, from about 0.07 MPa to about 10 MPa, from about 0.07 MPa to about 8 MPa, from about 0.07 MPa to about 6 MPa, from about 0.1 MPa to about 15 MPa, from about 0.1 MPa to about 12 MPa, from about 0.1 MPa to about 10 MPa, from about 0.1 MPa to about 8 MPa, from about 0.1 MPa to about 6 MPa, from about 0.5 MPa to about 15 MPa, from about 0.5 MPa to about 12 MPa, from about 0.5 MPa to about 10 MPa, from about 0.5 MPa to about 8 MPa, from about 0.5 MPa to about 6 MPa, from about 1 MPa to about 15 MPa, from about 1 MPa to about 12 MPa, from about 1 MPa to about 10 MPa, from about 1 MPa to about 8 MPa, from about 1 MPa to about 6 MPa, from about 3 MPa to about 15 MPa, from about 3 MPa to about 12 MPa, from about 3 MPa to about 10 MPa, from about 3 MPa to about 8 MPa, or from about 3 MPa to about 6 MPa, or any and all subranges formed from any of these endpoints.

### Thermoplastic Elastomer

In embodiments, the thermoplastic elastomer material may comprise thermoplastic elastomer.

Suitable thermoplastic elastomers may include conventional or commercially available thermoplastic elastomers. A thermoplastic elastomer may be used alone or in combination with one or more other thermoplastic elastomers.

In embodiments, the thermoplastic elastomer may be selected from the group consisting of thermoplastic polyurethanes (TPU) and styrenic block copolymers (SBC), wherein the styrenic block copolymers (SBC) are selected from the group consisting of styrene-ethylene/butylene-styrene (SEBS) block copolymers, styrene-ethylene/propylene-styrene (SEPS), styrene-ethylene/ethylene/propylene-styrene (SEEPS), styrene-isobutylene-styrene (SIBS), styrene-butadiene-styrene (SBS), styrene-isoprene-styrene (SIS), and combinations thereof.

In embodiments, the thermoplastic elastomer may be selected from virgin thermoplastic elastomer, recycled (recovered) thermoplastic elastomer, or combinations thereof.

In embodiments, the thermoplastic elastomer may be present in the thermoplastic elastomer material in an amount from about 50 wt % to about 99.9 wt %, based on weight of the thermoplastic elastomer material, or any and all subranges formed between these endpoints. For example, in embodiments, the thermoplastic elastomer may be present in an amount in the thermoplastic elastomer material from about 60 wt % to about 99.9 wt %, or from about 70 wt % to about 99.9 wt %, or from about 80 wt % to about 99.9 wt %, or from about 90 wt % to about 99.9 wt %, or from about 95 wt % to about 99.9 wt %, based on weight of the thermoplastic elastomer material, or any and all subranges formed between any of these endpoints.

### Magnetic Separation Additive

In embodiments, either the base component or the overmold component, but not both, may comprise magnetic separation additive.

In embodiments, the magnetic separation additive may be present in the base component and/or the rigid thermoplastic material used to form the base component, provided that the magnetic separation additive is not also present in the overmold component and/or the thermoplastic elastomer material used to form the overmold component. Alternatively, in embodiments, the magnetic separation additive may be present in the overmold component and/or the thermoplastic elastomer material used to form the overmold component, provided that the magnetic separation additive is not also present in the base component and/or the rigid thermoplastic material used to form the base component.

In embodiments, the magnetic separation additive may be present in an amount ranging from about (0.07/R) wt % to about (0.25/R) wt %, based on weight of the component in which the magnetic separation additive is present.

For example, in embodiments, the magnetic separation additive may be present, based on weight of the component in which the magnetic separation additive is present, in an amount that is greater than or equal to about (0.07/R), or about (0.075/R), or about (0.08/R), or about (0.09/R), or about (0.10/R); and less than or equal to about (0.25/R), or about (0.22/R), or about (0.20/R), or about (0.18/R), or about (0.16/R), or about (0.15/R); or any and all subranges formed between any of these endpoints.

In embodiments, the magnetic separation additive may have a magnetic induction at saturation point of about (1.7*R) tesla as measured by a vibrating sample magnetometer at 25 °C.

In embodiments, R may be a value from about 0.1 to about 2. For example, in embodiments, R may be a value greater than or equal to about 0.1, or greater than or equal to about 0.2, or greater than or equal to about 0.25; and, less than or equal to about 2, or less than or equal to about 1.5, or less than or equal to about 1.2; further, in embodiments, from about 0.1 to about 2, or from about 0.2 to about 1.5, or from about 0.25 to about 1.2, or any and all subranges formed from any of these endpoints.

As used herein, “R” is defined as the ratio between the magnetic induction at saturation point of any suitable magnetic separation additive relative to that of a defined reference magnetic separation additive. As used herein, the defined reference magnetic separation additive is a specific ferromagnetic stainless steel alloy powder available under the POLYMAG brand from Eriez Manufacturing, which has magnetic induction at saturation point of about 1.7 tesla as measured by a vibrating sample magnetometer at 25 °C (“POLYMAG”). Accordingly, R=1 for POLYMAG.

Suitable magnetic separation additives may include conventional or commercially available magnetic separation additives. A magnetic separation additive may be used alone or in combination with one or more other magnetic separation additives.

In embodiments, the magnetic separation additive may be a metal or a metal oxide. For example, in embodiments, the magnetic separation additive may be selected from the group consisting of iron, ferromagnetic steel allow, ferromagnetic stainless steel alloy, synthetic iron oxide with a chemical formula of Fe₃O₄, magnetite, ferrite, strontium ferrite, neodynium mixed oxides, alnico alloys, samarium-cobalt alloys, neodymium alloys, and combinations thereof.

In embodiments, when the magnetic separation additive is ferromagnetic stainless steel alloy powder, the magnetic separation additive may be present in an amount from about 0.05 wt % to about 1.0 wt %, based on weight of the component in which it is present, or any and all subranges formed between these endpoints.

For example, in embodiments, when the magnetic separation additive is ferromagnetic stainless steel and it is present in the thermoplastic elastomer material used to form the overmold layer, the amount of magnetic separation additive may be, based on weight of the thermoplastic elastomer material, greater than or equal to about 0.05 wt %, greater than or equal to about 0.06 wt %, or greater than or equal to about 0.075 wt %; and, less than or equal to about 1.0 wt %, or less than or equal to about 0.5 wt %, or less than or equal to about 0.4 wt %, or less than or equal to about 0.25 wt %; further, in embodiments, from about 0.05 wt % to about 1.0 wt %, or from about 0.06 wt % to about 0.4 wt %, or from about 0.075 wt % to about 0.25 wt %, or any and all subranges formed from any of these endpoints.

For further example, in embodiments, when the magnetic separation additive is ferromagnetic stainless steel alloy powder and R is a value of about 1, the magnetic separation additive may be present in an amount from about 0.07 wt % to about 0.25 wt %, based on weight of the component in which it is present, or any and all subranges formed between these endpoints.

For example, in other embodiments, when the magnetic separation additive is ferromagnetic stainless steel and it is present in the rigid thermoplastic material used to form the base layer, the amount of magnetic separation additive may be, based on weight of the rigid thermoplastic material, greater than or equal to about 0.05 wt %, greater than or equal to about 0.1 wt %, or greater than or equal to about 0.2 wt %; and, less than or equal to about 1 wt %, or less than or equal to about 0.5 wt %. Further, in embodiments, the amount of magnetic separation additive in the rigid thermoplastic material may be, based on weight of the rigid thermoplastic material, from about 0.05 wt % to about 1 wt %, from about 0.05 wt % to about 0.5 wt %, from about 0.1 wt % to about 1 wt %, from about 0.1 wt % to about 0.5 wt %, from about 0.2 wt % to about 1 wt %, or from about 0.2 wt % to about 0.5 wt %, or any and all subranges formed from any of these endpoints.

In embodiments, the magnetic separation additive may have an average particle size D50 from about 0.5 μm to about 200 μm, from about 0.5 μm to about 150 μm, from about 0.5 μm to about 100 μm, from about 0.5 μm to about 50 μm, from about 0.5 μm to about 25 μm, from about 0.5 μm to about 10 μm, from about 1 μm to about 200 μm, from about 1 μm to about 150 μm, from about 1 μm to about 100 μm, from about 1 μm to about 50 μm, from about 1 μm to about 25 μm, from about 1 μm to about 10 μm, from about 5 μm to about 200 μm, from about 5 μm to about 150 μm, from about 5 μm to about 100 μm, from about 5 μm to about 50 μm, from about 5 μm to about 25 μm, from about 5 μm to about 10 μm, from about 10 μm to about 200 μm, from about 10 μm to about 150 μm, from about 10 μm to about 100 μm, from about 10 μm to about 50 μm, from about 10 μm to about 25 μm, from about 25 μm to about 200 μm, from about 25 μm to about 150 μm, from about 25 μm to about 100 μm, from about 25 μm to about 50 μm, from about 50 μm to about 200 μm, from about 50 μm to about 150 μm, from about 50 μm to about 100 μm, from about 100 μm to about 200 μm, from about 100 μm to about 150 μm, or from about 150 μm to about 200 μm, or any and all subranges formed from these endpoints, as measured according to ASTM B822-20.

Suitable commercial embodiments of the magnetic separation additive are available under the POLYMAG brand from Eriez Manufacturing, such as ferromagnetic stainless steel powder grade; under the MICROMAG brand from Quality Magnetite, LLC, such as magnetite grade 5; and under the BAYFERROX brand from LANXESS, such as synthetic iron oxide powder grade 318M.

### Photoluminescent Marker

In embodiments, the article may further comprise a photoluminescent marker.

In embodiments, the photoluminescent marker may be applied onto an outer surface of the article. Additionally or alternatively, in embodiments, the photoluminescent marker may be incorporated into the base component (and/or the rigid thermoplastic material used to form the base component) and/or the overmold component (and/or the thermoplastic elastomer material used to form the overmold component. For example, in embodiments, the photoluminescent marker may be incorporated into either the base component (and/or the rigid thermoplastic material used to form the base component) or the overmold component (and/or the thermoplastic elastomer material used to form the overmold component, but not both.

In embodiments, the photoluminescent marker may emit a light spectrum that is visible to a human eye under normal lighting conditions. Likewise, in embodiments, the photoluminescent marker may emit a light spectrum that is visible to a human eye and/or detectable by a sensor when excited by an ultraviolet (UV), visible, or near infrared (IR) light source.

Accordingly, the photoluminescent marker may be used to facilitate identifying the article as a “recycle friendly” article. For example, in embodiments, the photoluminescent marker may comprise a brand or logo or other identifier that is visible to the human eye and indicates to a consumer that the article is a “recycle friendly” article. Further, in embodiments, the photoluminescent marker may be detectable by an automated optical sorter in a recycling process so that the “recycle friendly” articles may be sorted from other articles that are not “recycle friendly” prior to a granulation step.

In embodiments, the photoluminescent marker is thermally resistant such that it can withstand repeated heat exposures or heat histories that may be involved in multiple loops of recycling the articles and forming new articles by extrusion and/or molding processes.

In embodiments, the photoluminescent marker may comprise a thermoplastic carrier and at least one inorganic fluorophore.

In embodiments, the thermoplastic carrier may be the same as either the thermoplastic resin or the thermoplastic elastomer as described hereinabove.

In embodiments, the inorganic fluorophore may be selected from lanthanide-doped silicates or aluminates, manganese-doped silicates or aluminates, up-converting inorganic nanocrystals or lanthanide-doped nanoparticles (such as lanthanide-doped fluorides or lanthanide-doped metal oxide nanoparticles), semiconductor quantum dots, and combinations thereof.

In embodiments, the inorganic fluorophore has an average particle size that ranges from about 5 nm to about 100 microns.

In embodiments, the inorganic fluorophore is present in the photoluminescent marker from about 25 ppm to about 5000 ppm, based on weight on the photoluminescent marker.

In embodiments, the photoluminescent marker may be applied to an outer surface of the article by overmolding, mechanical interlocking, or direct printing without use of adhesive.

### Polymeric Chain Extender

In embodiments, the overmold component and/or the thermoplastic elastomer material may further comprise polymeric chain extender.

For example, in embodiments, the overmold component and/or the thermoplastic elastomer material may further comprise polymeric chain extender when the thermoplastic elastomer is selected from thermoplastic polyurethanes. In these embodiments, adding a polymeric chain extender to a thermoplastic elastomer material used to form an overmold component 104 may improve the tensile strength of the overmold component 104.

Suitable polymeric chain extenders may include conventional or commercially available polymeric chain extenders. A polymeric chain extender may be used alone or in combination with one or more other polymeric chain extenders.

For example, in embodiments, the polymeric chain extender may be selected from functional styrene acrylic copolymers with epoxy groups.

In embodiments, the polymeric chain extender may be present in an amount from about 0.2 wt % to about 1.0 wt %, based on weight of the overmold component 104 or based on weight of the thermoplastic elastomer material if and as applicable.

In embodiments, the amount of polymeric chain extender in the overmold component 104 may be, based on weight of the overmold component 104, greater than or equal to about 0.2 wt % or greater than or equal to about 0.4 wt %. In embodiments, the amount of polymeric chain extender in the overmold component 104, based on a total weight of the overmold component 104, may be less than or equal to about 2 wt %, less than or equal to about 1.5 wt %, less than or equal about 1 wt % or less than or equal to about 0.8 wt %. In embodiments, the amount of polymeric chain extender in the overmold component 104, based on a total weight of the overmold component 104, may be from about 0.2 wt % to about 2 wt %, from about 0.2 wt % to about 1.5 wt %, from about 0.2 wt % to about 1 wt %, from about 0.2 wt % to about 0.8 wt %, from about 0.4 wt % to about 2 wt %, from about 0.4 wt % to about 1.5 wt %, from about 0.4 wt % to about 1 wt %, or from about 0.4 wt % to about 0.8 wt %, or any and all subranges formed from any of these endpoints.

Suitable commercial embodiments of the polymeric chain extender are available under the JONCRYL brand from BASF, such as functional styrene acrylic copolymer with epoxy groups grade ADR 4400.

### Other Additives

In embodiments, one or both of the rigid thermoplastic material and the thermoplastic elastomer material may further comprise one or more optional other additives.

Suitable additives may include conventional or commercially available plastics additives. Those skilled in the art of thermoplastics compounding, without undue experimentation, may select suitable additives from available references, for example, E. W. Flick, “Plastics Additives Database,” Plastics Design Library (Elsevier 2004).

Optional other additives may be used in any amount that is sufficient to obtain a desired processing or performance property for the material or component formed therefrom. The amount should not be wasteful of the additive nor detrimental to the processing or performance.

For example, in embodiments, one or more optional other additives may be present in the material in an amount from 0 wt % to about 40 wt %, or from about 0.01 wt % to about 20 wt %, or from about 0.1 wt % to about 10 wt %, based on weight of the material, or any and all subranges formed between any of these endpoints.

Non-limiting examples of optional other additives may include adhesion promoters; antioxidants; biocides; anti-fogging agents; anti-static agents; bonding agents and bonding polymers; dispersants; fillers; flame retardants and smoke suppressants; impact modifiers; initiators; lubricants; micas; colorants (pigments and/or dyes); plasticizers; processing aids; release agents; silanes, titanates, and zirconates; slip and anti-blocking agents; stearates; ultraviolet light absorbers; viscosity regulators; waxes; and combinations thereof.

In embodiments, one or both of the rigid thermoplastic material and the thermoplastic elastomer material may comprise inorganic filler. For example, in embodiments, the inorganic filler may be selected from the group consisting of chopped glass fibers, glass beads, talc, clays, calcium carbonates, and combinations thereof.

In embodiments, one or both of the rigid thermoplastic material and the thermoplastic elastomer material may comprise antioxidants. Suitable commercial embodiments of antioxidants are available under the IRGANOX brand from BASF, such as grade B225.

### Additional Component

In embodiments, the article may further comprise an additional component comprising an additional thermoplastic material, wherein the additional thermoplastic material is (a) the same as the rigid thermoplastic material, or (b) the same as the recovered thermoplastic elastomer material, or (c) different from each of the rigid thermoplastic material and the recovered thermoplastic elastomer material.

In embodiments, the additional component may comprise a separation additive that is the same as, or different from, the separation additive included in the rigid thermoplastic material.

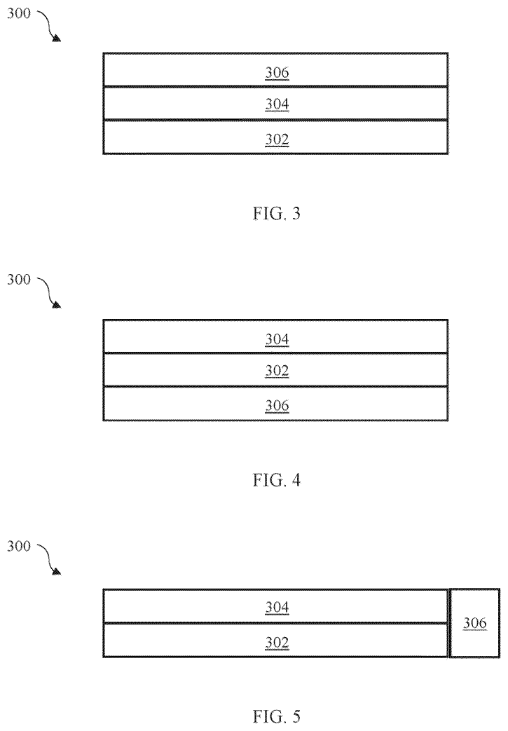

Referring now to FIGS. 3-5, an article 300 comprising a base component 302 comprising rigid thermoplastic material and an overmold component 304 comprising thermoplastic elastomer material may further comprise an additional component 306 comprising an additional thermoplastic material. The additional component 306 may be affixed to overmold component 304 as shown in FIG. 3, to base component 302 as shown in FIG. 4, or both base component 302 and overmold component 304 as shown in FIG. 5. Non-limiting examples of methods of affixing component 306 may include overmolding, gluing, and mechanical fastening.

Method of Separating and/or Recovering

Methods disclosed herein are directed to separating and/or recovering a high-purity thermoplastic material from an overmolded thermoplastic article.

In embodiments, the method may comprise the steps of (a) providing the article as disclosed herein as the overmolded thermoplastic article; (b) reducing the overmolded thermoplastic article to provide a regrind mixture; (c) separating the regrind mixture into at least (i) a first fraction collected in a first bin, (ii) a second fraction collected in a second bin, and (iii) a third fraction collected in a third bin.

Surprisingly, it has been discovered that, when using at least three bins and separating the regrind mixture into at least three fractions, even when only relatively small amounts of magnetic separation additive are included in either the base component or the overmold component, it is possible to separate substantial fractions of the rigid thermoplastic material used to form the base component from substantial fractions of the thermoplastic elastomer material used to form the overmold component and achieve unexpectedly high purities for one or both of these separated and recovered thermoplastic materials. More specifically, as demonstrated by the Examples below, it has been discovered that, when using at least three bins and separating the regrind mixture into at least three fractions, even when only relatively small amounts of magnetic separation additive are included in either the base component or the overmold component, it is possible to achieve not only high purity for the material of the component that does not contain the magnetic separation additive, but also unexpectedly higher purity for the material of the component that contains the magnetic separation additive.

In embodiments, step (a) may comprise providing the article as disclosed herein as the overmolded thermoplastic article.

In embodiments, step (b) may comprise reducing the overmolded thermoplastic article to provide a regrind mixture.

In embodiments, the reducing step may comprise crushing, shredding, grinding, granulation, or a combination thereof to produce regrind. In some embodiments, such as post-consumer recycling processes, the reducing step may comprise reducing the overmolded thermoplastic article itself to produce regrind. In other embodiments, such as post-industrial applications, the reducing step may comprise reducing scrap material from a process for manufacturing the overmolded thermoplastic article to produce regrind.

In embodiments, the regrind mixture may comprise at least three different types of regrind particles: type-1 regrind particles, type-2 regrind particles, and type-3 regrind particles.

In embodiments, each of the type-1 regrind particles may comprise greater than or equal to 80 wt % of the rigid thermoplastic material and less than or equal to 20 wt % of the thermoplastic elastomer material, based on weight of each of the type-1 regrind particles. Accordingly, the type-1 regrind particles may be characterized as those regrind particles that have a substantial portion of the rigid thermoplastic material but not a substantial portion of the thermoplastic elastomer material. The type-1 regrind particles may also be referred to as “rigid thermoplastic rich” particles.

In embodiments, each of the type-2 regrind particles may comprise less than or equal to 20 wt % of the rigid thermoplastic material and greater than or equal to 80 wt % of the thermoplastic elastomer material, based on weight of each of the type-2 regrind particles. Accordingly, the type-2 regrind particles may be characterized as those regrind particles that have a substantial portion of the thermoplastic elastomer material but not a substantial portion of the rigid thermoplastic material. The type-2 regrind particles may also be referred to as “thermoplastic elastomer rich” regrind particles.

In embodiments, each of the type-3 regrind particles may comprise at least 20 wt % of the rigid thermoplastic material and at least 20 wt % of the thermoplastic elastomer material, based on weight of each of the type-3 regrind particles. Accordingly, the type-3 particles may be characterized as those regrind particles that have both a substantial portion of rigid thermoplastic material and a substantial portion of thermoplastic elastomer material. The type-3 regrind particles may also be referred to as “hybrid” or “commingled” particles.

In embodiments, the type-3 regrind particles are present in an amount from about 5 wt % to about 50 wt %, based on weight of the regrind mixture.

In embodiments, step (c) may comprise separating the regrind mixture into at least (i) a first fraction collected in a first bin, (ii) a second fraction collected in a second bin, and (iii) a third fraction collected in a third bin.

In embodiments, the first fraction may comprise at least 75 wt % or 80 wt % or 85 wt % or 90 wt % of a first neat material, based on weight of the first fraction.

In embodiments, the second fraction may comprise at least 90 wt % of a second neat material, based on weight of the second fraction.

In embodiments, the third fraction may comprise from about 20 wt % to about 80 wt % of the first neat material and from about 80 wt % to about 20 wt % of the second neat material, based on weight of the third fraction.

In embodiments, from about 5 wt % to about 50 wt % of the regrind mixture, based on weight of the regrind mixture, is separated into the third fraction;

In embodiments, if the magnetic separation additive is present in the base component, the first neat material is the rigid thermoplastic material and the second neat material is the thermoplastic elastomer material.

In embodiments, if the magnetic separation additive is present in the overmold component, the first neat material is the thermoplastic elastomer material and the second neat material is the rigid thermoplastic material.

In embodiments, the high-purity recovered thermoplastic material is selected from either the first fraction or the second fraction or both the first fraction and the second fraction.

In embodiments, the step of separating is performed by a magnetic pulley separator equipped with a rare-earth magnetic roll.

According to methods previously known, magnetic separation may be performed using two bins and separating the regrind mixture into two fractions.

For example, referring now to FIG. 2, a magnetic pulley separator 200 includes a belt conveyor 202 and a magnetic roll 204. The separator 200 includes a splitter 206 and two collection bins 208, 210.

The collection bin 208 collects predominantly regrind particles of the component material without magnetic separation additive and a fraction of regrind particles that comprise 80 wt % or more of the component material without magnetic separation additive and 20% or less of the component material with magnetic separation additive.

The collection bin 210 collects predominantly regrind particles of the component material with magnetic separation additive. These include both hybrid particles and particles that comprise 80 wt % or more of the component material with magnetic separation additive and 20 wt % or less of the component material without magnetic separation additive.

The splitter 206 may be adjustable to achieve high-purity and acceptable recovery rate of recovered material of the component without magnetic separation additive in the collection bin 208.

In contrast, according to the methods disclosed herein, magnetic separation may be performed using at least three bins and separating the regrind mixture into at least three fractions.

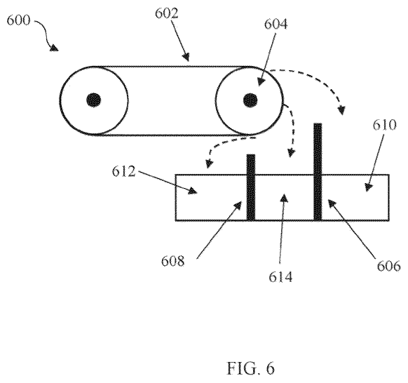

For example, referring now to FIG. 6, a magnetic pulley separator 600 includes a belt conveyor 602 and a magnetic roll 604. The separator 600 includes two splitters 606, 608 and three collection bins 610, 612, 614. In other embodiments, additional splitters and collection bins may be included to allow for separation into more than three fractions.

The position and angular orientation of the splitters 606, 608 may be adjustable to achieve high purities and acceptable recovery rates of recovered materials of the both components of the overmolded thermoplastic articles.

The collection bin 610 collects predominantly regrind particles of the component material without magnetic separation additive and a fraction of particles that comprise 80 wt % or more of the component without magnetic separation additive and 20 wt % or less of the component with magnetic separation additive.

The collection bins 612 and 614 collect predominantly regrind particles with magnetic separation additive. These include both hybrid regrind particles and regrind particles that comprise 80 wt % or more of the component material with magnetic separation additive and 20 wt % or less of the component material without magnetic separation additive. The collection bin 614 also may be referred to as the “middling” bin or as used to collect the “middling” fraction.

For example, if the magnetic separation additive is present in the base component, the collection bin 610 collects predominantly “thermoplastic elastomer rich” regrind particles, the collection bin 612 collects predominantly “rigid thermoplastic rich” regrind particles, and the collection bin 614 collects predominantly “hybrid” regrind particles.

For further example, if the magnetic separation additive is present in the overmold component, the collection bin 610 collects predominantly “rigid thermoplastic rich” regrind particles, the collection bin 612 collects predominantly “thermoplastic elastomer rich” regrind particles, and the collection bin 614 collects predominantly “hybrid” regrind particles.

With regrind of an overmolded thermoplastic article in which hybrid regrind particles are present, a goal of achieving high purity of a component often may be contradictory to the goal of achieving high recovery rate of the same component. It is believed that a compromise may be made to achieve high purity along with a less than best but still acceptable recovery rate because the high purity of the recovered material is typically critical for a closed-loop recycling process which enables the recovered material to be used subsequently to form new articles.

### EXAMPLES

Non-limiting examples of various embodiments of the disclosed invention are provided.

Table 1 shows ingredients used in the examples.

TABLE 1

| Reference | Ingredient | Brand and Grade | Source |
|---|---|---|---|
| TPU | Thermoplastic elastomer | VERSAFLEX CE 3120-65 | Avient Corporation |
| | material (thermoplastic | | |
| | polyurethane compound) | | |
| PC | Rigid thermoplastic material | MAKROLON 2407 | Covestro AG |
| | (polycarbonate) | | |
| POLYMAG | Magnetic separation additive | POLYMAG | Eriez Mfg. Co. |
| | (ferromagnetic stainless steel | | |
| | powder) | | |
| MICROMAG | Magnetic separation additive | MICROMAG 5 | Quality Magnetite, LLC |
| | (magnetite powder) | | |

The examples were regrind mixtures of overmolded thermoplastic articles comprising an overmold component (OC) formed from TPU and a base component (BC) formed from PC with different loading levels of magnetic separation (MS) additive in the OC or the BC as specified in Tables 2 to 6 below.

The overmolded thermoplastic articles of each example were in the form of flat plaques of 100 mm×100 mm×3.2 mm. The OC was formed by overmolding a layer of TPU onto a side of a previously formed layer of PC forming the BC such that the OC completely covered the side of the BC. Layer thicknesses and the weight ratio of the TPU relative to the PC in each of the overmolded thermoplastic articles were as specified in Tables 2 to 6 below.

The regrind mixtures were generated by grinding the plaques of each overmolded thermoplastic article into particles with lateral sizes between 0.5 mm and a maximum particle size as specified in Tables 2 to 6 below. Maximum particle size was controlled in the grinder by using a perforated metal screen with perforated holes of the maximum particle size.

The regrind mixtures were separated by magnetic separation using a lab-scale magnetic pulley separator with a 5 inch wide belt conveyor and a rare-earth magnetic roll from Eriez Manufacturing Co. Inc. The roll was constructed of discs of neodymium-boron-iron permanent magnets sandwiched with steel pole pieces. The steel poles had been magnetically induced to the saturation point of approximately 24,000 gauss. The average strength of the magnetic field measured at the surface of the roll was at least 10,000 gauss. The thickness of the belt was about 0.25 mm. The belt speed was 160 ft/min. The feed rate was 300 lb/hr/foot belt width.

During a one set of magnetic separation runs, a “two bin” configuration, like as shown in FIG. 2, was used. During another set of magnetic separation runs, a “three bin” configuration, like as shown in FIG. 6, was used. In each case, the regrind mixtures of each example were run for one pass. Results are shown in Tables 2 to 6 below.

Table 2 shows certain compositional details and certain results of separation processes performed for Comparative Example C1 and Examples E1 to E4.

TABLE 2

| Example | | C1 | E1 | E2 |
|---|---|---|---|---|
| COMPOSITION | | | | |
| Article | Overmold component (OC) material | TPU | TPU | TPU |
| | OC layer thickness (mm) | 1.6 | 1.6 | 1.6 |
| | Base component (BC) material | PC | PC | PC |
| | BC layer thickness (mm) | 1.6 | 1.6 | 1.6 |
| | Weight ratio OC to BC | 48:52 | 48:52 | 48:52 |
| Magnetic | Type | POLYMAG | POLYMAG | POLYMAG |
| separation | Magnetic induction | 1.70 | 1.70 | 1.70 |
| (MS) | at saturation (tesla) | | | |
| additive | R value | 1.0 | 1.0 | 1.0 |
| | Component where present | OC | OC | OC |
| | Loading level (wt%) | 0.05 | 0.075 | 0.10 |
| Regrind | Maximum particle size (mm) | 8 | 8 | 8 |
| RESULTS | | | | |
| Results of 2-bin magnetic separation | | | | |
| OC rich | Purity of OC material (%) | 87 | 80 | 72 |
| fraction | Recovery rate of OC material (%) | 84 | 93 | 96 |
| BC rich | Purity of BC material (%) | 86 | 93 | 97 |
| fraction | Recovery rate of BC material (%) | 89 | 79 | 68 |
| Results of 3-bin magnetic separation | | | | |
| OC rich | Purity of OC material (%) | 96 | 94 | 88 |
| fraction | Recovery rate of OC material (%) | 20 | 61 | 72 |
| BC rich | Purity of BC material (%) | 86 | 93 | 97 |
| fraction | Recovery rate of BC material (%) | 89 | 79 | 68 |
| Middling | Purity of OC material (%) | 85 | 63 | 48 |
| fraction | Weight % relative to total regrind | 37 | 25 | 25 |
| Absolute difference of 3-bin relative to 2-bin | | | | |
| OC rich | Purity of OC material (%) | 9 | 14 | 16 |
| fraction | Recovery rate of OC material (%) | −65 | −32 | −25 |
| BC rich | Purity of BC material (%) | 0 | 0 | 0 |
| fraction | Recovery rate of BC material (%) | 0 | 0 | 0 |
| Percentage difference of 3-bin relative to 2-bin | | | | |
| OC rich | Purity of OC material (%) | +10% | +17% | +22% |
| fraction | Recovery rate of OC material (%) | −76% | −35% | −26% |
| BC rich | Purity of BC material (%) | 0% | 0% | 0% |
| fraction | Recovery rate of BC material (%) | 0% | 0% | 0% |

| Example | | E3 | E4 |
|---|---|---|---|
| COMPOSITION | | | |
| Article | Overmold component (OC) material | TPU | TPU |
| | OC layer thickness (mm) | 1.6 | 1.6 |
| | Base component (BC) material | PC | PC |
| | BC layer thickness (mm) | 1.6 | 1.6 |
| | Weight ratio OC to BC | 48:52 | 48:52 |
| Magnetic | Type | POLYMAG | POLYMAG |
| separation | Magnetic induction | 1.70 | 1.70 |
| (MS) | at saturation (tesla) | | |
| additive | R value | 1.0 | 1.0 |
| | Component where present | OC | OC |
| | Loading level (wt %) | 0.15 | 0.25 |
| Regrind | Maximum particle size (mm) | 8 | 8 |
| RESULTS | | | |
| Results of 2-bin magnetic separation | | | |
| OC rich | Purity of OC material (%) | 70 | 70 |
| fraction | Recovery rate of OC material (%) | 98 | 97 |
| | Purity of BC material (%) | 97 | 99 |
| BC rich | Recovery rate of BC material (%) | 61 | 63 |
| fraction | | | |
| Results of 3-bin magnetic separation | | | |
| OC rich | Purity of OC material (%) | 83 | 76 |
| fraction | Recovery rate of OC material (%) | 83 | 94 |
| BC rich | Purity of BC material (%) | 97 | 99 |
| fraction | Recovery rate of BC material (%) | 61 | 63 |
| Middling | Purity of OC material (%) | 37 | 22 |
| fraction | Weight % relative to total regrind | 19 | 8 |
| Absolute difference of 3-bin relative to 2-bin | | | |
| OC rich | Purity of OC material (%) | +13 | +6 |
| fraction | Recovery rate of OC material (%) | −15 | −4 |
| BC rich | Purity of BC material (%) | 0 | 0 |
| fraction | Recovery rate of BC material (%) | 0 | 0 |
| Percentage difference of 3-bin relative to 2-bin | | | |
| OC rich | Purity of OC material (%) | +19% | +9% |
| fraction | Recovery rate of OC material (%) | −15% | −4% |
| BC rich | Purity of BC material (%) | 0% | 0% |
| fraction | Recovery rate of BC material (%) | 0% | 0% |

Table 3 shows certain compositional details and certain results of separation processes performed for Example E5 and Comparative Example C2.

TABLE 3

| Example | | E5 | C2 |
|---|---|---|---|
| COMPOSITION | | | |
| Article | Overmold component (OC) material | TPU | TPU |
| | OC layer thickness (mm) | 1.6 | 1.6 |
| | Base component (BC) material | PC | PC |
| | BC layer thickness (mm) | 1.6 | 1.6 |
| | Weight ratio OC to BC | 48:52 | 48:52 |
| Magnetic | Type | POLYMAG | POLYMAG |
| separation | Magnetic induction | 1.70 | 1.70 |
| (MS) | at saturation (tesla) | | |
| additive | R value | 1.0 | 1.0 |
| | Component where present | OC | OC |
| | Loading level (wt%) | 0.18 | 0.50 |
| Regrind | Maximum particle size (mm) | 5 | 5 |
| RESULTS | | | |
| Results of 2-bin magnetic separation | | | |
| OC rich | Purity of OC material (%) | 84 | 85 |
| fraction | Recovery rate of OC material (%) | 100 | 100 |
| BC rich | Purity of BC material (%) | 99 | 99 |
| fraction | Recovery rate of BC material (%) | 82 | 82 |
| Results of 3-bin magnetic separation | | | |
| OC rich | Purity of OC material (%) | 90 | 88 |
| fraction | Recovery rate of OC material (%) | 96 | 99 |
| BC rich | Purity of BC material (%) | 99 | 99 |
| fraction | Recovery rate of BC material (%) | 82 | 82 |
| Middling | Purity of OC material (%) | 23 | 3 |
| fraction | Weight % relative to total regrind | 6 | 3 |
| Absolute difference of 3-bin relative to 2-bin | | | |
| OC rich | Purity of OC material (%) | +6 | +3 |
| fraction | Recovery rate of OC material (%) | −4 | −1 |
| BC rich | Purity of BC material (%) | 0 | 0 |
| fraction | Recovery rate of BC material (%) | −1 | −1 |
| Percentage difference of 3-bin relative to 2-bin | | | |
| OC rich | Purity of OC material (%) | +7% | +4% |
| fraction | Recovery rate of OC material (%) | −4% | −1% |
| BC rich | Purity of BC material (%) | 0% | 0% |
| fraction | Recovery rate of BC material (%) | −1% | −1% |

Table 4 shows certain compositional details and certain results of separation processes performed for Comparative Examples C3 to C4 and Example E6.

TABLE 4

| Example | | C3 | E6 | C4 |
|---|---|---|---|---|
| COMPOSITION | | | | |
| Article | Overmold component (OC) material | TPU | TPU | TPU |
| | OC layer thickness (mm) | 1.6 | 1.6 | 1.6 |
| | Base component (BC) material | PC | PC | PC |
| | BC layer thickness (mm) | 1.6 | 1.6 | 1.6 |
| | Weight ratio OC to BC | 48:52 | 48:52 | 48:52 |
| Magnetic | Type | POLYMAG | POLYMAG | POLYMAG |
| separation | Magnetic induction | 1.70 | 1.70 | 1.70 |
| (MS) | at saturation (tesla) | | | |
| additive | R value | 1.0 | 1.0 | 1.0 |
| | Component where present | BC | BC | BC |
| | Loading level (wt%) | 0.05 | 0.10 | 0.50 |
| Regrind | Maximum particle size (mm) | 5 | 5 | 5 |
| RESULTS | | | | |
| Results of 2-bin magnetic separation | | | | |
| OC rich | Purity of OC material (%) | 88 | 96 | 99 |
| fraction | Recovery rate of OC material (%) | 83 | 79 | 72 |
| BC rich | Purity of BC material (%) | 87 | 86 | 80 |
| fraction | Recovery rate of BC material (%) | 92 | 99 | 100 |
| Results of 3-bin magnetic separation | | | | |
| OC rich | Purity of OC material (%) | 88 | 96 | 99 |
| fraction | Recovery rate of OC material (%) | 84 | 80 | 72 |
| BC rich | Purity of BC material (%) | 97 | 96 | 83 |
| fraction | Recovery rate of BC material (%) | 8 | 76 | 100 |
| Middling | Purity of OC material (%) | 13 | 38 | 87 |
| fraction | Weight % relative to total regrind | 51 | 19 | 2 |
| Absolute difference of 3-bin relative to 2-bin | | | | |
| | Purity of OC material (%) | 0 | 0 | 0 |
| OC rich | Recovery rate of OC material (%) | +1 | +1 | 0 |
| fraction | | | | |
| BC rich | Purity of BC material (%) | +10 | +10 | +3 |
| fraction | Recovery rate of BC material (%) | −84 | −23 | 0 |
| Percentage difference of 3-bin relative to 2-bin | | | | |
| OC rich | Purity of OC material (%) | 0% | 0% | 0% |
| fraction | Recovery rate of OC material (%) | +1% | +1% | 0% |
| BC rich | Purity of BC material (%) | +11% | +11% | +4% |
| fraction | Recovery rate of BC material (%) | −92% | −23% | 0% |

Table 5 shows certain compositional details and certain results of separation processes performed for Example E7 and Comparative Example C5.

TABLE 5

| Example | | E7 | C5 |
|---|---|---|---|
| COMPOSITION | | | |
| Article | Overmold component (OC) material | TPU | TPU |
| | OC layer thickness (mm) | 1.1 | 1.1 |
| | Base component (BC) material | PC | PC |
| | BC layer thickness (mm) | 2.1 | 2.1 |
| | Weight ratio OC to BC | 34:66 | 34:66 |
| Magnetic | Type | POLYMAG | POLYMAG |
| separation | Magnetic induction | 1.70 | 1.70 |
| (MS) | at saturation (tesla) | | |
| additive | R value | 1.0 | 1.0 |
| | Component where present | BC | BC |
| | Loading level (wt%) | 0.18 | 1.00 |
| Regrind | Maximum particle size (mm) | 5 | 5 |
| RESULTS | | | |
| Results of 2-bin magnetic separation | | | |
| OC rich | Purity of OC material (%) | 98 | 98 |
| fraction | Recovery rate of OC material (%) | 59 | 61 |
| | Purity of BC material (%) | 83 | 84 |
| BC rich | Recovery rate of BC material (%) | 100 | 99 |
| fraction | | | |
| Results of 3-bin magnetic separation | | | |
| OC rich | Purity of OC material (%) | 98 | 99 |
| fraction | Recovery rate of OC material (%) | 59 | 28 |
| BC rich | Purity of BC material (%) | 88 | 84 |
| fraction | Recovery rate of BC material (%) | 96 | 99 |
| Middling | Purity of OC material (%) | 66 | 95 |
| fraction | Weight % relative to total regrind | 8 | 35 |
| Absolute difference of 3-bin relative to 2-bin | | | |
| OC rich | Purity of OC material (%) | 0 | +1 |
| fraction | Recovery rate of OC material (%) | 0 | −33 |
| BC rich | Purity of BC material (%) | +5 | 0 |
| fraction | Recovery rate of BC material (%) | −4 | 0 |
| Percentage difference of 3-bin relative to 2-bin | | | |
| OC rich | Purity of OC material (%) | 0% | +1% |
| fraction | Recovery rate of OC material (%) | 0% | −54% |
| BC rich | Purity of BC material (%) | +6% | 0% |
| fraction | Recovery rate of BC material (%) | −4% | 0% |

Table 6 shows certain compositional details and certain results of separation processes performed for Comparative Example C6.

TABLE 6

| Example | | C6 |
|---|---|---|
| COMPOSITION | | |
| Article | Overmold component (OC) material | TPU |
| | OC layer thickness (mm) | 1.6 |
| | Base component (BC) material | PC |
| | BC layer thickness (mm) | 1.6 |
| | Weight ratio OC to BC | 48:52 |
| | Type | MICROMAG |
| Magnetic | Magnetic induction | 0.490 |
| separation | at saturation (tesla) | |
| (MS) | R value | 0.3 |
| additive | Component where present | BC |
| | Loading level (wt%) | 0.12 |
| Regrind | Maximum particle size (mm) | 5 |
| RESULTS | | |
| Results of 2-bin magnetic separation | | |
| OC rich | Purity of OC material (%) | 86 |
| fraction | Recovery rate of OC material (%) | 93 |
| BC rich | Purity of BC material (%) | 93 |
| fraction | Recovery rate of BC material (%) | 86 |
| Results of 3-bin magnetic separation | | |
| OC rich | Purity of OC material (%) | 86 |
| fraction | Recovery rate of OC material (%) | 93 |
| BC rich | Purity of BC material (%) | 96 |
| fraction | Recovery rate of BC material (%) | 12 |
| Middling | Purity of OC material (%) | 8 |
| fraction | Weight % relative to total regrind | 42 |
| Absolute difference of 3-bin relative to 2-bin | | |
| OC rich | Purity of OC material (%) | 0 |
| fraction | Recovery rate of OC material (%) | 0 |
| BC rich | Purity of BC material (%) | +3 |
| fraction | Recovery rate of BC material (%) | −74 |
| Percentage difference of 3-bin relative to 2-bin | | |
| OC rich | Purity of OC material (%) | 0% |
| fraction | Recovery rate of OC material (%) | 0% |
| BC rich | Purity of BC material (%) | +3% |
| fraction | Recovery rate of BC material (%) | −87% |

As demonstrated by the examples, it has been discovered that, when using at least three bins and separating the regrind mixture into at least three fractions, even when only relatively small amounts of magnetic separation additive are included in either the base component or the overmold component, it is possible to achieve not only high purity for the material of the component that does not contain the magnetic separation additive, but also unexpectedly higher purity for the material of the component that contains the magnetic separation additive.

For example, when POLYMAG was used as the magnetic separation additive at a loading level from about 0.075 wt % to about 0.25 wt %, it was observed that purity of the material of the component containing POLYMAG unexpectedly increased when it was recovered in a 3-bin separation process, like as shown in FIG. 6, relative to when it was recovered in a 2-bin separation process, like as shown in FIG. 2.

In contrast, when POLYMAG was used as the magnetic separation additive at a loading level lower than about 0.075 wt. % and higher than about 0.25 wt %, not much additional benefit was observed.

For example, in Comparative Examples C1 and C3, it is believed that the use of POLYMAG at a loading level of 0.05 wt %, in either the OC or the BC, was too low such that the major portion of the regrind particles that comprise at least 80 wt % of the component containing POLYMAG (type-2 regrind particles in C1 and type-1 regrind particles in C3) had too weak of a response to the magnetic roll, which resulted in these regrind particles being collected in the middling bin 614 and being mixed up with the hybrid regrind particles also collected there. Correspondingly, the recovery rate in C1 and C3 was observed to drop sharply compared to that in Examples E1 and E6, respectively.

Further, when POLYMAG was used at a loading level of 0.25 wt % or higher, in either the BC or the OC, it is believed that relatively lower purities of the materials collected in bin 612 were observed because the majority of hybrid regrind particles were believed to have had take-off trajectories from the belt of the separator similar to those of the type-1 or type-2 regrind particles (whichever comprise at least 80 wt % of the component containing POLYMAG), which resulted in relatively lower purities of the materials collected in bin 612.

If a magnetic separation additive different from POLYMAG is used, it is believed that the ratio between the magnetic induction at the saturation point of the different magnetic separation additive and that of POLYMAG (i.e., the R value of the different magnetic separation additive) may be considered to determine a range of loading levels of the different magnetic separation additive that may result in increased purity when using a 3-bin separation process versus a 2-bin separation process. For the different magnetic separation additive, the corresponding range of loading levels may be from about (0.07/R) wt % to about (0.25/R) wt %.

For example, MICROMAG, which is a magnetic separation additive different from POLYMAG, has an R value of 0.3. Hence, it is believed that the lower limit of the range of loading levels that would result in increased purity would be about 0.23 wt %. Further, for example, in Comparative Example C6, MICROMAG was used as the magnetic separation additive at a loading level of 0.12 wt % in the BC, which was less than the calculated lower limit loading level. Correspondingly, it was observed that C6 had a 3-bin separation result similar to that of Comparative Example C3 which included POLYMAG at a loading level of 0.05 wt % (i.e., at a level that was observed to be too low for POLYMAG as discussed above).

Additionally, it should be noted that the results of Table 2 may not be directly compared to those of Table 3 because the maximum regrind particle size is 8 mm in the former set of examples and 5 mm in the latter set of examples.

It is believed that regrind particle size may affect the separation results independent of the loading level and location of the magnetic separation additive.

It is further believed that using a size reduction or granulation process to generate relatively smaller regrind particles may result in a greater amount of type-1 and type-2 regrind particles and a lesser amount of hybrid particles.

It is even further believed that having a lesser amount of hybrid regrind particles in a regrind mixture with relatively smaller particle sizes would improve the purities of both the OC rich fraction and BC rich fraction when using both the 2-bin and 3-bin separation processes.

However, it is believed that the range of loading levels of magnetic separation additive that may result in increased purity when using a 3-bin separation process versus a 2-bin separation process does not significantly change when the maximum particle sizes is about 8 mm or less.

Every document cited herein is incorporated herein by reference in its entirety unless otherwise specified. The citation of any document is not to be construed as an admission that it is prior art with respect to any invention disclosed or claimed herein. To the extent that any meaning or definition of a term in this document conflicts with any meaning or definition of the same term in a document incorporated by reference, the meaning or definition assigned to that term in this document shall govern.

It will be apparent that modifications and variations are possible without departing from the scope of the disclosure defined in the appended claims. Although some aspects of the present disclosure are identified herein as preferred or particularly advantageous, it is contemplated that the present disclosure is not necessarily limited to these aspects.

What is claimed is:

1. An article comprising:
(a) a base component comprising rigid thermoplastic material; and
(b) an overmold component comprising thermoplastic elastomer material;
wherein:
(i) either the base component or the overmold component, but not both, comprises magnetic separation additive in an amount ranging from about (0.07/R) wt % to about (0.25/R) wt %, based on weight of the component in which the magnetic separation additive is present;
(ii) the magnetic separation additive has a magnetic induction at saturation point of about (1.7*R) tesla as measured by a vibrating sample magnetometer at 25 °C; and
(iii) R is a value from about 0.1 to about 2.

2. The article of claim 1, wherein at least a portion of the overmold component is affixed onto at least a portion of the base component.

3. The article of claim 1, wherein the article further comprises a photoluminescent marker.

4. The article of claim 3, wherein the photoluminescent marker is affixed onto an outer surface of the article.

5. The article of claim 3, wherein the photoluminescent marker is incorporated into either the rigid thermoplastic material used to form the base component or the thermoplastic elastomer material used to form the overmold component, but not both.

6. The article of claim 3, wherein the photoluminescent marker comprises at least one inorganic fluorophore selected from the group consisting of lanthanide-doped silicates or aluminates; manganese-doped silicates or aluminates; lanthanide-doped nanoparticles; semiconductor quantum dots; and combinations thereof.

7. The article of claim 1, wherein the magnetic separation additive is selected from the group consisting of iron, ferromagnetic steel alloy, ferromagnetic stainless steel alloy, synthetic iron oxide with a chemical formula of Fe₃O₄, magnetite, ferrite, strontium ferrite, neodynium mixed oxides, alnico alloys, samarium-cobalt alloys, neodymium alloys, and combinations thereof.

8. The article of claim 1, wherein R is a value from about 0.25 to about 1.2, and the magnetic separation additive is ferromagnetic stainless steel alloy, magnetite, or a combination thereof.

9. The article of claim 1, wherein R is a value of about 1, the magnetic separation additive is a ferromagnetic stainless steel alloy, and the magnetic separation additive is present in an amount from about 0.07 wt % to about 0.25 wt %, based on weight of the component in which the magnetic separation additive is present.

10. The article of claim 1, wherein the rigid thermoplastic material comprises thermoplastic resin selected from the group consisting of polycarbonates, thermoplastic polyesters, polyamides, aliphatic polyketones, acrylonitrile butadiene styrenes, polypropylenes, and combinations thereof.

11. The article of claim 1, wherein the thermoplastic elastomer material comprises thermoplastic elastomer selected from the group consisting of thermoplastic polyurethanes (TPU) and styrenic block copolymers (SBC), and wherein the styrenic block copolymers (SBC) are selected from the group consisting of styrene-ethylene/butylene-styrene (SEBS) block copolymers, styrene-ethylene/propylene-styrene (SEPS), styrene-ethylene/ethylene/propylene-styrene (SEEPS), styrene-isobutylene-styrene (SIBS), styrene-butadiene-styrene (SBS), styrene-isoprene-styrene (SIS), and combinations thereof.

12. The article of claim 1, wherein the thermoplastic elastomer is selected from thermoplastic polyurethanes and the overmold component further comprises a polymeric chain extender, wherein the polymeric chain extender is selected from functional styrene acrylic copolymers with epoxy groups, and wherein the polymeric chain extender is present from about 0.2 wt % to about 2.0 wt %, based on weight of the overmold component.

13. The article of claim 1, wherein one or both of the rigid thermoplastic material and the thermoplastic elastomer material further comprises one or more other additives selected from the group consisting of adhesion promoters; antioxidants; biocides; anti-fogging agents; anti-static agents; bonding agents; dispersants; fillers; flame retardants and smoke suppressants; impact modifiers; initiators; lubricants; micas; colorants (pigments and/or dyes); plasticizers; processing aids; release agents; silanes, titanates, and zirconates; slip and anti-blocking agents; stearates; ultraviolet light absorbers; viscosity regulators; and waxes.

14. The article of claim 1, wherein the article is a protective case or cover for an electronic device, and the electronic device is capable of sending and/or receiving wireless telecommunication signals at frequencies between about 1 GHz and about 50 GHz.

15. A method of recovering a high-purity recovered thermoplastic material from an overmolded thermoplastic article, the method comprising steps of:
(a) providing the article of any preceding claim as the overmolded thermoplastic article;
(b) reducing the overmolded thermoplastic article to provide a regrind mixture;
(c) separating the regrind mixture into at least (i) a first fraction collected in a first bin, (ii) a second fraction collected in a second bin, and (iii) a third fraction collected in a third bin;
wherein at least 99 wt % of the regrind mixture, based on weight of the regrind mixture, has a particle size from about 0.5 mm (US mesh size 35) to about 8 mm (US mesh size 5/16 inch); and
the separating is performed by a magnetic pulley separator equipped with a rare-earth magnetic roll having a roll surface and an average strength of magnetic field of at least 10,000 gauss at the roll surface.

16. The method of claim 15, wherein the regrind mixture comprises:
(a) type-1 regrind particles, each of the type-1 regrind particles comprising greater than 80 wt % of the rigid thermoplastic material and less than 20 wt % of the thermoplastic elastomer material, based on weight of each of the type-1 regrind particles;
(b) type-2 regrind particles, each of the type-2 regrind particles comprising less than 20 wt % of the rigid thermoplastic material and greater than 80 wt % of the thermoplastic elastomer material, based on weight of each of the type-2 regrind particles; and
(c) type-3 regrind particles, each of the type-3 regrind particles comprising at least 20 wt % of the rigid thermoplastic material and at least 20 wt % of the thermoplastic elastomer material, based on weight of each of the type-3 regrind particles; and
wherein the type-3 regrind particles are present in an amount from about 5 wt % to about 50 wt %, based on weight of the regrind mixture.

17. The method of claim 15, wherein:
(a) the first fraction comprises at least 75 wt % of a first neat material, based on weight of the first fraction;
(b) the second fraction comprises at least 90 wt % of a second neat material, based on weight of the second fraction; and
(c) the third fraction comprises from about 20 wt % to about 80 wt % of the first neat material and from about 80 wt % to about 20 wt % of the second neat material, based on weight of the third fraction; and
wherein:
(A) if the magnetic separation additive is present in the base component, the first neat material is the rigid thermoplastic material and the second neat material is the thermoplastic elastomer material; and
(B) if the magnetic separation additive is present in the overmold component, the first neat material is the thermoplastic elastomer material and the second neat material is the rigid thermoplastic material.

18. The method of claim 17, wherein the first fraction comprises at least 80 wt % or 85 wt % or 90 wt % of the first neat material, based on weight of the first fraction.

19. The method of claim 15, wherein the high-purity recovered thermoplastic material is selected from either the first fraction or the second fraction or both the first fraction and the second fraction.

20. A method of recovering a high-purity recovered thermoplastic material from an overmolded thermoplastic article, the method comprising steps of:
(a) providing the article of claim 1 as the overmolded thermoplastic article;
(b) reducing the overmolded thermoplastic article to provide a regrind mixture comprising:
(i) type-1 regrind particles, each of the type-1 regrind particles comprising greater than 80 wt % of the rigid thermoplastic material and less than 20 wt % of the thermoplastic elastomer material, based on weight of each of the type-1 regrind particles;
(ii) type-2 regrind particles, each of the type-2 regrind particles comprising less than 20 wt % of the rigid thermoplastic material and greater than 80 wt % of the thermoplastic elastomer material, based on weight of each of the type-2 regrind particles; and
(iii) type-3 regrind particles, each of the type-3 regrind particles comprising at least 20 wt % of the rigid thermoplastic material and at least 20 wt % of the thermoplastic elastomer material, based on weight of each of the type-3 regrind particles;
wherein:
(A) at least 99 wt % of the regrind mixture, based on weight of the regrind mixture, has a particle size from about 0.5 mm (US mesh size 35) to about 8 mm (US mesh size 5/16 inch); and
(B) the type-3 regrind particles are present in an amount from about 5 wt % to about 50 wt %, based on weight of the regrind mixture; and
(c) separating the regrind mixture into at least:
(i) a first fraction collected in a first bin, the first fraction comprising at least 75 wt % of a first neat material, based on weight of the first fraction;
(ii) a second fraction collected in a second bin, the second fraction comprising at least 90 wt % of a second neat material, based on weight of the second fraction; and
(iii) a third fraction collected in a third bin, the third fraction comprising from about 20 wt % to about 80 wt % of the first neat material and from about 80 wt % to about 20 wt % of the second neat material, based on weight of the third fraction;
wherein:
(A) the separating is performed by a magnetic pulley separator equipped with a rare-earth magnetic roll having a roll surface and an average strength of magnetic field of at least 10,000 gauss at the roll surface;
(B) from about 5 wt % to about 50 wt % of the regrind mixture, based on weight of the regrind mixture, is separated into the third fraction;
(C) if the magnetic separation additive is present in the base component, the first neat material is the rigid thermoplastic material and the second neat material is the thermoplastic elastomer material;
(D) if the magnetic separation additive is present in the overmold component, the first neat material is the thermoplastic elastomer material and the second neat material is the rigid thermoplastic material; and
(E) the high-purity recovered thermoplastic material is selected from either the first fraction or the second fraction or both the first fraction and the second fraction.
